(19) United States
(12) Patent Application Publication
(10) Pub. No.: US 2009/0009313 A1
(43) Pub. Date: Jan. 8, 2009

(54) SYSTEM AND METHOD FOR PROMOTING SAFE DRIVING

(76) Inventor: Joseph M. Pippins, SR., Olathe, KS (US)

Correspondence Address: MARK BROWN, 4700 BELLEVIEW SUITE 210, KANSAS CITY, MO, 64112, US

(21) Appl. No.: 12/167,179

(22) Filed: Jul. 2, 2008

Related U.S. Application Data
(60) Provisional application No. 60/947,816, filed on Jul. 3, 2007.

(51) Int. Cl. B60Q 1/00

(52) U.S. Cl. 340/457.1; 340/438

(57) ABSTRACT

A system for promoting safe driving includes a hazard detector connected to the vehicle electrical system and providing an output signal corresponding to an unsafe condition, such as an unbuckled passive restraint. The output signal activates a relay, which interrupts operation of another vehicle system, such as the sound system. A method of promoting safe driving includes detecting an internal or external hazard and interrupting operation of a vehicle system in response thereto.

### BACKGROUND OF THE INVENTION

1. Field of the Invention

The present invention relates generally to vehicle safety, and in particular to a system and method for promoting safe driving by interrupting certain vehicle functions, such as a sound system, in the event of unsafe driving.

2. Description of the Related Art

Various types of vehicle safety devices and equipment have been developed to promote safe driving practices. Passive restraints, e.g., seatbelts and shoulder harnesses, are well-known to reduce the risk of personal injury associated with vehicle accidents and have been standard equipment on new vehicles for several decades. Similarly, vehicle safety seats are in widespread usage for infants. However, many passive restraint systems require occupant action (i.e. buckling the restraining straps) to achieve their operating configurations. The consistent usage of passive restraints is promoted in many modern vehicles by illuminating warning lights and activating audio alerts in the event an occupant fails to buckle the passive restraint for the seat occupied by him or her. However, such alerts and passive indicators are often ignored whereby the vehicle occupants are put at risk.

Exceeding posted speed limits and driving too last for road, weather and traffic conditions are other forms of unsafe driving practices, which are linked to many accidents. Although technically feasible to control and limit vehicle speeds, drivers typically have discretion in controlling the speed of their vehicles. Interfering with vehicle performance could actually endanger drivers and passengers in some situations, such as passing at speed when drivers may require maximum performance from their vehicles in order to safely complete passing maneuvers.

Sound systems are installed in most passenger vehicles and utilize a wide variety of designs and configurations. More sophisticated sound systems include multiple speakers installed at various locations in the vehicles. The sound sources typically comprise receivers, CD/DVD players, etc. Such sound systems can provide entertainment for drivers and passengers. Accordingly, sound systems and the musical and other materials which comprise their output are commonly of considerable interest to the occupants of the vehicle.

The present invention addresses these considerations. Heretofore there has not been available a system and method for promoting safe driving with the advantages and features of the present invention.

### SUMMARY OF THE INVENTION

In the practice of an aspect of the present invention, a vehicle safety system is provided with a hazard detector connected to a relay, which in turn is connected to a vehicle sound system for providing power thereto via the vehicle's electrical system. The hazard detector can be activated by various unsafe driving conditions, such as driving without all occupants secured by passive restraint devices, driving too fast, excessive acceleration, etc. An aspect of the present invention involves interrupting vehicle sound system operation upon the detection of an unsafe condition.

Upon detecting an unsafe driving condition, the vehicle safety system terminates the power supply or otherwise interrupts the sound system. A method of promoting safe driving involves the steps of detecting an unsafe driving condition and temporarily deactivating a vehicle sound system in response thereto. Upon correcting the unsafe condition, the vehicle sound system is reactivated.

The specific parameters of unsafe conditions can be preprogrammed and vary from vehicle-to-vehicle and among different drivers and passengers. For example, prior to allowing someone else to use his or her vehicle, the owner can preprogram the sound system to shut down in the event all occupants are not safely secured with their passive restraint devices and the vehicle operated within safe speed ranges, taking into account road, traffic and weather conditions. Other types of safety reminders can also be employed, such as prerecorded safety messages and reminders. Still further, better driving habits for increased vehicle safety can be promoted with positive reinforcement, such as permitting the use of the sound system, providing greater material content choices, etc. as a direct consequence of utilizing available safety equipment while operating within predetermined safety and performance parameters. Vehicle insurance premiums, which are commonly related to drivers' driving records and accident histories, can also be positively affected by fewer accidents as a consequence of using the system of the present invention. Vehicle insurance companies often provide premium deductions and discounts for drivers and vehicles with good driving and safety records. The system of the present invention can conceivably provide a benefit in the form of lower insurance premiums.

### BRIEF DESCRIPTION OF THE DRAWINGS

FIG. 1 is a block diagram of a vehicle safety system embodying an aspect of the present invention.

FIG. 2 is a partial view of a vehicle passive restraint device, shown in an unbuckled condition.

FIG. 3 is another partial view of the vehicle passive restraint device, shown in a buckled condition.

FIG. 4 is a block diagram of another aspect of the present invention, including seat sensors and passive restraint switches connected to a relay via a bus.

FIG. 5 is a block diagram of another aspect of the invention, including a wiring harness with multiple switches for detecting unsafe driving conditions.

FIG. 6 is a block diagram thereof, showing an unsafe driving condition represented by the driver's passive restraint device being unbuckled.

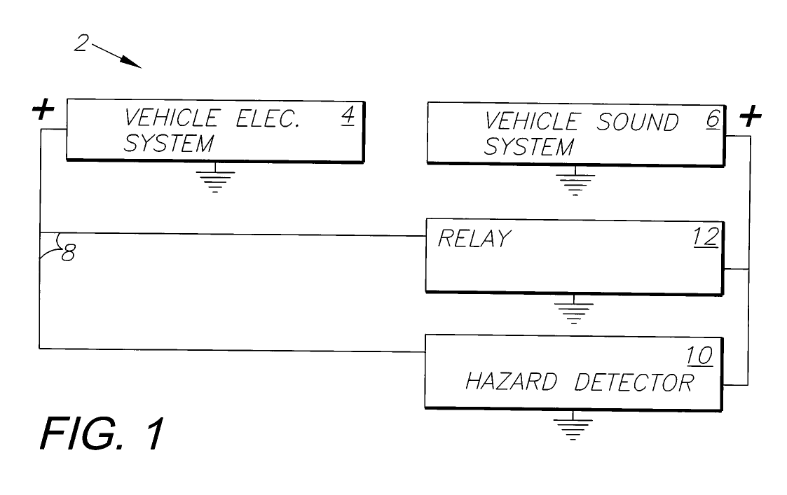

### DETAILED DESCRIPTION OF THE PREFERRED EMBODIMENTS

### I. Introduction and Environment

As required, detailed embodiments of the present invention are disclosed herein; however, it is to be understood that the disclosed embodiments are merely exemplary of the invention, which may be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure.

Certain terminology will be used in the following description for convenience in reference only and will not be limiting. For example, up, down, front, back, right and left refer to the invention as oriented in the view being referred to. The words “inwardly” and “outwardly” refer to directions toward and away from, respectively, the geometric center of the embodiment being described and designated parts thereof. Forwardly and rearwardly are generally in reference to the vehicle on which the system is mounted, if appropriate. Said terminology will include the words specifically mentioned, derivatives thereof and words of similar meaning.

Referring to the drawings in more detail, the reference numeral 2 generally designates a vehicle safety system embodying an aspect of the present invention. Without limitation on the generality of useful applications of the system 2, an exemplary application is on a passenger vehicle, which includes an electrical system 4 and a sound system 6. Also without limitation, the vehicle electrical system 4 can provide a source of DC electrical power indicated by the “+” designation for positive potential (e.g., 12V), with grounding provided by the vehicle body and chassis. The various system 2 components are connected by a suitable wiring harness 8. A hazard detector 10 is connected to the vehicle electrical system 4 and can comprise a wide range of components, including sensors, detectors and devices for providing an output signal to an optional relay 12. Examples include switch gear, infrared and ultrasonic detectors, motion detectors, heat sensors, etc. Hazards can comprise a wide range of conditions, both internal and external to the vehicle. Internally, unbuckled passive restraint devices at occupied seats comprise a safety hazard, which either activates the relay 12 to deactivate the sound system 6, or directly interrupts operation of the sound system 6. Externally, road, traffic and weather conditions, vehicle speed and other potential hazards can similarly be detected and provide an interruption signal.

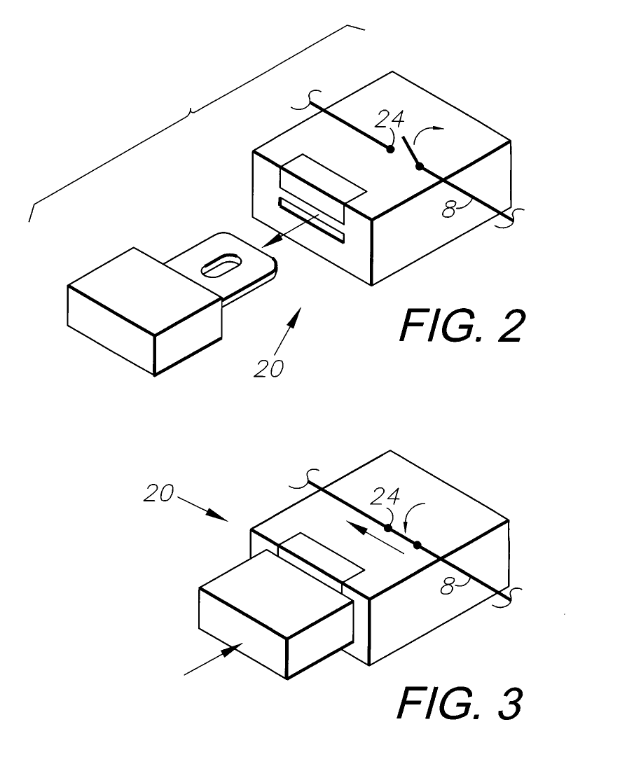

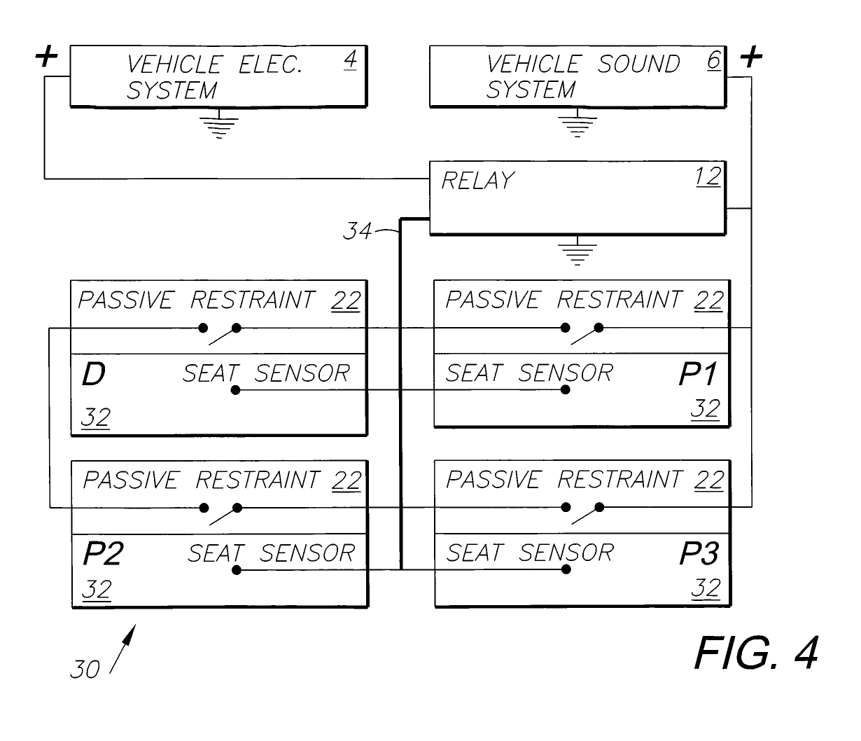

FIGS. 2 and 3 show a buckle 20 for a passive restraint 22. The buckle 20 includes a switch 24, which is open in an unbuckled condition (FIG. 2) and closed in a buckled condition (FIG. 3). These operating conditions can be reversed. FIG. 4 shows another aspect of the invention comprising a safety system 30 installed in a vehicle with four seats designated Driver (D), Passenger 1 (P1), Passenger 2 (P2) and Passenger 3 (P3), each of which is equipped with a seat sensor 32, which detects an occupant. Passive restraints 22 are located at each seat and include switches 24. The sensors 32 and the switches 24 provide signals to a common bus 34, which is connected to the relay 12. Upon sensing an occupant at a particular seat location, the operation of the sound system 6 is automatically interrupted unless the corresponding passive restraint is buckled, as determined by the passive restraint buckle switches 24. The safety system 30 can be configured to provide outputs for alerting the vehicle occupants to the unsafe condition which is causing the sound system malfunction. Such alerts can include audible reminder signals, indicator lights, text displayed on a graphical user interface (GUI), etc.

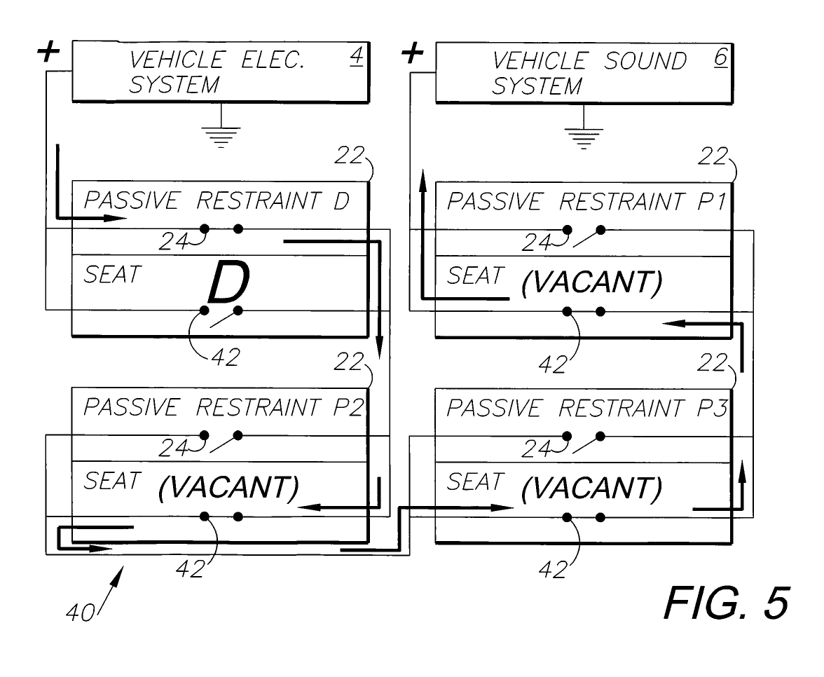

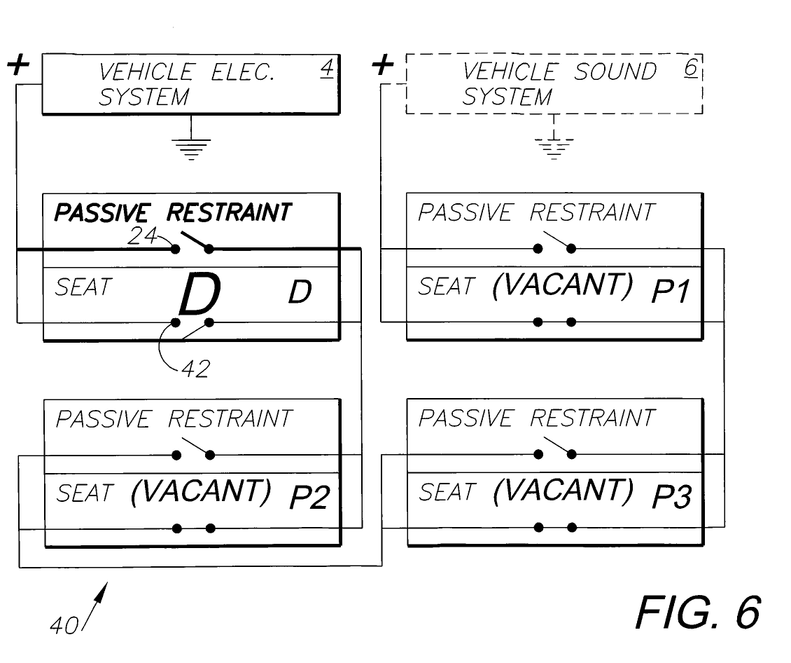

FIGS. 5 and 6 show another aspect of the invention comprising a safety system 40 with switches 42 located at each seat for determining the presence of an occupant, e.g. the driver D, who opens the corresponding switch 42 by sitting down. FIG. 5 shows the safe condition with the passive restraint D buckled and its corresponding switch 24 closed whereby power flows from the vehicle electrical system 4 through the driver's seat. Because the other seats are vacant, their corresponding seat switches 42 remain closed whereby electrical power flows continuously through all of the vehicle seats and reaches the sound system 6 for activating same. The circuit of FIG. 5 thus comprises four parallel switch circuits each associated with a seat, which parallel circuits are connected in series whereby a power interruption at any seat interrupts the power supply to the sound system 6. FIG. 6 shows the unsafe condition with the driver's passive restraint unbuckled and the power flow interrupted. The driver can operate the sound system 6 only when he or she buckles the passive restraint 22.

It is to be understood that the invention can be embodied in various forms, and is not to be limited to the examples discussed above. Other components and configurations can be utilized in the practice of the present invention. For example, a vehicle cruise control can be utilized to interrupt the operation of the sound system upon detecting an excessive speed condition. The system can be preprogrammed to interrupt the sound system when a predetermined speed is exceeded. Other vehicle systems can also be controlled by the safety systems described above. For example, power windows, sunroofs, vehicle occupant comfort systems such as heating and air-conditioning, and other systems can be interrupted and otherwise partly controlled by the safety systems. Moreover, the systems are designed for both retrofit and OEM applications. Retrofitting the vehicle safety systems can be facilitated by utilizing existing vehicle components, such as switch gear associated with passive restraints and vehicle seats, which is common on many vehicles currently in production and use.

Having thus described the invention, what is claimed as new and desired to be secured by Letters Patent is:

1. A safety system for a vehicle including an electrical system and an electrical device connected to the electrical system, which safety system comprises:
a hazard detector connected to the electrical system and having a hazard state providing a hazard output corresponding to a hazard condition and a safe state;
an electrical interconnect interconnecting said electrical device and said hazard detector; and
said electrical device being inoperative in response to the hazard output.

2. The safety system of claim 1 wherein:
electrical power to said electrical device is provided via said electrical interconnect with said hazard detector in a safe state; and
electrical power to said electrical device is interrupted in response to the hazard output.

3. The safety system of claim 1, which includes:
said vehicle including first and second passive restraints;
said hazard detector comprising a first passive restraint switch connected to said first passive restraint;
said hazard detector including a second passive restraint switch connected to said second passive restraint; and
said hazard state corresponding to an unbuckled condition of a respective passive restraint.

4. The safety system of claim 3, which includes:
each said passive restraint switch having an open, hazard state with a respective passive restraint unbuckled.

5. The safety system of claim 4 wherein said hazard detector includes first and second occupant detection switches each connected in parallel with a respective passive restraint switch.

6. The safety system of claim 5 wherein:
said parallel first passive restraint and occupant detection switches are connected in series with said second passive restraint and occupant detection switches; and
said hazard state comprises either of said passive restraints being unbuckled with a respective occupant detection switch being open.

7. The safety system of claim 6, which includes:
said electrical device being chosen from among the group consisting of: a vehicle sound system, a vehicle ignition system, an audible alarm and a vehicle light.

8. The safety system of claim 2, which includes:
said electrical interconnect comprising a relay.

9. The safety system of claim 1, which includes:
an occupant detection sensor chosen from among the group comprising an infrared sensor, an ultrasound sensor and an electrical switch; and
said interconnect including a bus connected to said hazard detector and said occupant detection sensor and an electrical relay connected to said bus and said electrical device.

10. The safety system of claim 3, which includes:
said interconnect including a switch network comprising said switches.

11. A method of controlling an electrical device in a vehicle with an electrical system, multiple seats and multiple passive restraints each associated with a respective seat, which method includes the steps of:
providing each said seat with an occupant detection switch having a closed position with said seat unoccupied and an open position with said seat occupied;
providing each said passive restraint with a passive restraint switch having an open position with said passive restraint unbuckled and a closed position with said pass restraint buckle;
connecting each said occupant detection switch in parallel with a respective passive restraint switch; and
connecting said parallel-connected occupant detection and passive restraint switch pairs in series;
forming a hazard detection network with said occupant detection and passive restraint switches; and
connecting said hazard detection network with the vehicle electrical system and the electrical device.

12. The method according of 11, which includes the additional step of:
providing the vehicle with an electrical device chosen from among the group consisting of a vehicle sound system, a vehicle ignition system, an audible alarm and a vehicle light.

13. The method of claim 11, which includes the additional steps of:
providing an electrical relay; and
connecting the hazard detection network with the electrical device via the relay.

14. In combination with a vehicle including an electrical system, an electrical device, multiple seats and multiple passive restraints each associated with a respective seat, the improvement of a safety system comprising:
multiple hazard detectors each having a hazard state providing a hazard output corresponding to a hazard condition and a safe state;
each said hazard detector including a passive restraint switch connected to a respective passive restraint and an occupant detection switch connected in parallel with a respective passive restraint switch;
each said passive restraint switch having an open, hazard state with a respective passive restraint unbuckled;
an electrical interconnect interconnecting said electrical device and said hazard detector;
electrical power to said electrical device being provided via said electrical interconnect with said hazard detectors in said safe states;
electrical power to said electrical device being interrupted in response to the hazard output;
said parallel-connected pairs of first passive restraint and occupant detection switches being connected in series; and
said electrical device being chosen from among the group consisting of: a vehicle sound system, a vehicle ignition system, an audible alarm and a vehicle light.

15. The safety system of claim 14, which includes:
said electrical interconnect comprising a relay.
